(19) United States
(12) Patent Application Publication
(10) Pub. No.: US 2022/0016570 A1
(43) Pub. Date: Jan. 20, 2022

(54) SELECTIVELY PERMEABLE POLYMERIC MEMBRANE

(71) Applicant: NITTO DENKO CORPORATION, Osaka (JP)

(72) Inventors: Shijun Zheng, San Diego, CA (US); Weiping Lin, Carlsbad, CA (US); Peng Wang, San Diego, CA (US); Isamu Kitahara, San Diego, CA (US); Bita Bagge, Vista, CA (US); John Ericson, Poway, CA (US); Wanyun Hsieh, San Diego, CA (US); Yuji Yamashiro, Osaka (JP); Takashi Kondo, Osaka (JP)

(21) Appl. No.: 17/414,812

(22) PCT Filed: Dec. 12, 2019
(86) PCT No.: PCT/US19/66083

§ 371 Date: Jun. 16, 2021

Related U.S. Application Data
(60) Provisional application No. 62/780,524, filed on Dec. 17, 2018.

(51) Int. Cl. B01D 53/26; B01D 69/12; B01D 71/80; B01D 71/52; B01D 71/56; B01D 71/58; B01D 71/68; B01D 69/10; B01D 69/02; B01D 53/22; B01D 67/00

(52) U.S. Cl. CPC B01D 53/268; B01D 69/12; B01D 71/80; B01D 71/52; B01D 71/56; B01D 71/58; B01D 2325/20; B01D 69/10; B01D 69/02; B01D 53/228; B01D 67/0088; B01D 67/0095; B01D 2325/04; B01D 71/68

(57) ABSTRACT

Described herein are polymeric based composite membranes that provide selective resistance for gases while providing water vapor permeability. Such composite membranes have a high water/air selectivity in permeability. The methods for making such membranes and using the membranes for dehydrating or removing water vapor from gases are also described.

### CROSS-REFERENCE TO RELATED APPLICATIONS

This application claims the benefit of U.S. Provisional Application No. 62/780,524, filed Dec. 17, 2018, which is incorporated by reference in its entirety.

### FIELD

The present embodiments are related to polymeric membranes, including membranes comprising polymeric materials for applications such as removing water or water vapor from air or other gas streams and energy recovery ventilation (ERV).

### BACKGROUND

The presence of a high moisture level in the air may make people uncomfortable, and also may cause serious health issues by promoting growth of mold, fungus, as well as dust mites. In manufacturing and storage facilities, high humidity environments may accelerate product degradation, powder agglomeration, seed germination, corrosion, and other undesired effects, which is a concern for chemical, pharmaceutical, food and electronic industries. One of the conventional methods to dehydrate air include passing wet air through hydroscopic agents, such as glycol, silica gel, molecular sieves, calcium chloride, and phosphorus pentoxide. This method has many disadvantages, for example, the drying agent has to be carried over in a dry air stream; and the drying agent also requires a replacement or regeneration over time, which makes the dehydration process costly and time consuming. Another conventional method of dehydration of air is a cryogenic method involving compressing and cooling the wet air to condense moisture, however, this method is highly energy consuming.

Compared with traditional dehydration or dehumidification technologies described above, membrane-based gas dehumidification technology has distinct technical and economic advantages. The advantages include low installation investment, easy operation, high energy efficiency, low process cost, and high processing capacity. This technology has been successfully applied in dehydration of nitrogen, oxygen, and compressed air. For energy recovery ventilator (ERV) applications, such as inside buildings, it is desirable to provide fresh air from outside. Energy is required to cool and dehumidify the fresh air, especially in hot and humid climates, where the outside air is much hotter and has more moisture than the air inside the building. The amount of energy required for heating and cooling can be reduced by transferring heat and moisture between the exhausting air and incoming fresh air through an ERV system. The ERV system comprising a membrane which separates the exhausting air and incoming air physically but allows the heat and moisture exchange. The required key characteristics of the ERV membrane include: (1) low permeability of air and gases other than water vapors; (2) high permeability of water vapor for effective transfer of moisture between the incoming and the outgoing air stream while blocking the passage of other gases; and (3) high thermal conductivity for effective heat transfer.

There is a need of membranes with high permeability of water vapor and low permeability of air for ERV applications.

### SUMMARY

The disclosure relates to selectively permeable membranes where a high moisture permeability and a low gas permeability may be useful to effect dehydration of a gas. Some membranes may provide an improved dehydration as compared to traditional polymers, such as polyvinyl alcohols (PVA), poly(acrylic acid) (PAA), and polyether ether ketone (PEEK). Some membranes may comprise a hydrophilicity agent. The polymeric membrane composition may be prepared by using one or more water soluble polymers/hydrophilicity agents. Methods of efficiently and economically making these membrane compositions are also described. Water can be used as a solvent in preparing these membrane compositions, which makes the membrane preparation process more environmentally friendly and more cost effective.

Some embodiments include a dehydration membrane comprising: a porous support; and a composite coated on the porous support comprising a polyether block amide (PEBA), a Poly(diallyldimethylammonium chloride)(PDADMA), a poly(acrylamide-co-diallyldimethylammonium chloride)(PACD), a poly(sodium 4-styrenesulfonate)(PSS), or a combination thereof.

Some embodiments include a method for dehydrating a gas comprising: applying a first gas to a dehydration membrane described herein; and allowing the water vapor to pass through the dehydration membrane and to be removed; and generating a second gas that has lower water vapor content than the first gas.

Some embodiments include a method of making a dehydration membrane comprising: curing an aqueous mixture that is coated onto a porous support; wherein the aqueous mixture that is coated onto the porous support is dried at a temperature of 60° C. to 100° C. for about 30 seconds to about 3 hours; wherein the porous support is coated with the aqueous mixture by applying the aqueous mixture to the porous support, and repeating as necessary to achieve a layer of coating having a thickness of about 100 nm to about 10000 nm; and wherein the aqueous mixture is formed by mixing a PEBA, a PDADMA, a PACD, a PSS, or a combination thereof, in an aqueous liquid.

### BRIEF DESCRIPTION OF THE DRAWINGS

FIG. 1 is a depiction of a possible embodiment of a selective dehydration membrane.

FIG. 2 is a depiction of a possible embodiment for the method/process of making a separation/dehydration membrane element.

### DETAILED DESCRIPTION

### General

A selectively permeable membrane includes a membrane that is relatively permeable to one material and relatively impermeable for another material. For example, a membrane may be relatively permeable to water vapor and relatively impermeable to gases such as oxygen and/or nitrogen. The ratio of permeability for different materials may be useful in describing their selective permeability.

These membranes may also have antimicrobial activity, such as an antimicrobial activity of at least about 1, at least about 2, at least about 3, about 1-2, about 2-3, or about 1-3 according to Japanese Industrial Standard Z 2801:2012. Antimicrobial activity may help to prevent contamination and/or the accumulation of biofilm on the membrane.

### Dehydration Membrane

The present disclosure relates to dehydration membranes where a highly selective hydrophilic composite material with high water vapor permeability, low gas permeability and high mechanical and chemical stability may be useful in applications where a dry gas or gas with low water vapor content is desired.

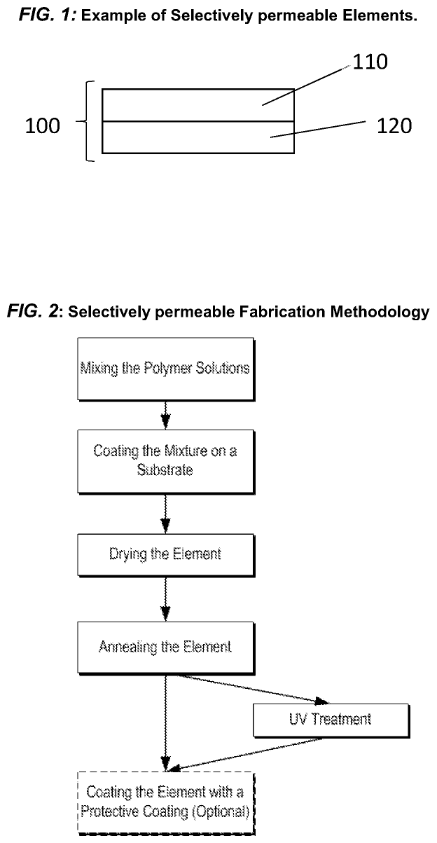

Generally, a dehydration membrane comprises a porous support and a composite coated onto the support. For example, as depicted in FIG. 1, a selectively permeable membrane, such as membrane 100 can include at least a porous support, such as porous support 120. A polymeric composite, such as polymeric composite 110 is coated onto porous support 120. As a result of the layers, the selectively permeable device may provide a durable dehydration system that is selectively permeable to water vapor, and less permeable to one or more gases. As a result of the layers, the selectively permeable device may provide a durable dehydration system that may effectively dehydrate air or other desired gases or feed fluids.

In some embodiments, the porous support comprises a polymer or hollow fibers. The porous support may be sandwiched between two composite layers. The polymeric composite may further be in fluid communication with the support.

An additional optional layer, such as a protective layer, may also be present. In some embodiments, the protective layer can comprise a hydrophilic polymer. In some embodiments, the hydrophilic polymer may be different from the aforementioned polymers in the composite, e.g., PEBA. A protective layer may be placed in any position that helps to protect the selectively permeable membrane, such as a water permeable membrane, from harsh environments, such as compounds which may deteriorate the layers, radiation, such as ultraviolet radiation, extreme temperatures, etc.

In some embodiments, the gas passing through the membrane travels through all the components regardless of whether they are in physical communication or their order of arrangement.

A dehydration or water permeable membrane, such as one described herein, can be used to remove moisture from a gas stream. In some embodiments, a membrane may be disposed between a first gas component and a second gas component such that the components are in fluid communication through the membrane. In some embodiments, the first gas may contain a feed gas upstream and/or at the permeable membrane.

In some embodiments, the membrane can selectively allow water vapor to pass through while keeping other gases or a gas mixture, such as air, from passing through. In some embodiments, the membrane may have high moisture permeability. In some embodiments, the membrane can have low or no permeability to a gas or a gas mixture such as N2 or air. In some embodiments, the membrane may be a dehydration membrane. In some embodiments, the membrane may be an air dehydration membrane. In some embodiments, the membrane may be a gas separation membrane. In some embodiments, a membrane that is moisture permeable and/or gas impermeable barrier membrane may provide desired selectivity between water vapor and other gases. In some embodiments, the selectively permeable membrane may comprise multiple layers.

In some embodiments, the moisture permeability may be measured by water vapor transfer rate. In some embodiments, the membrane exhibits a normalized water vapor flow rate of about 500-2000 g/m²/day; about 1000-2000 g/m²/day, about 1000-1500 g/m²/day, about 1500-2000 g/m²/day, about 1000-1700 g/m²/day; about 1200-1500 g/m²/day; about 1300-1500 g/m²/day, at least about 500 g/m²/day, about 500-1000 g/m²/day, about 500-750 g/m²/day, about 750-1000 g/m²/day, about 600-800 g/m²/day, about 800-1000 g/m²/day, or about 1000 g/m²/day, about 1200 g/m²/day, about 1300 g/m²·day, at least 1000 g/m²/day, or at least 1450 g/m²/day, or any normalized volumetric water vapor flow rate in a range bounded by any of these values. For the purposes of the present disclosure, the units of measurement for expressing water vapor transmission rate (also called water vapor transfer rate) may be g/m²/day, g/m²·day, or g/m² per day. A suitable method for determining moisture (water vapor) transfer rates is ASTM E96.

In some embodiments, the dehydration membrane has a gas permeance that is less than 0.001 L/(m²Spa), less than 10⁻⁴ L/(m²Spa), less than 10⁻⁵ L/(m²Spa), less than 10⁻⁶ L/(m²Spa), less than 10⁻⁷ L/(m²Spa), less than 10⁻⁸ L/(m²Spa), less than 10⁻⁹ L/(m²Spa), or less than 10⁻¹⁰ L/(m²Spa), as determined by the Differential Pressure Method. For the purposes of the present disclosure, the units of measurement for expressing gas permeance may be L/(m²Spa), L/m² s Pa, L/m²·s·Pa, L/(m² s Pa), or L/(m²·s·Pa). A suitable method for determining gas permeability can be the Differential Pressure Method, ASTM D-726-58, TAPPI-T-536-88 standard method.

### Porous Support

A porous support may be any suitable material and in any suitable form upon which a layer, such as a layer of the composite, may be deposited or disposed. In some embodiments, the porous support can comprise hollow fibers or porous material. In some embodiments, the porous support may comprise a porous material, such as a polymer or a hollow fiber. Some porous supports can comprise a non-woven fabric. In some embodiments, the polymer may be polyamide (Nylon), polyimide (P1), polyvinylidene fluoride (PVDF), polyethylene (PE), polypropylene (PP) (including stretched polypropylene), polyethylene terephthalate (PET), polysulfone (PSF), polyether sulfone (PES), cellulose acetate, polyacrylonitrile (e.g. PA200), or a combination thereof. In some embodiments, the polymer can comprise PET. In some embodiments the polypropylene is distended from a first length to a second length, where in the second length is at least 25%, 40%, 50%, 75% and/or greater than 100% of the first length. In some embodiments the polypropylene is distended from a first length to a second length, within 1 minute, 5 minutes, 10 minutes and/or 1 hour, wherein the second length is at least 25%, 40%, 50%, 75% and/or greater than 100% of the first length.

### Composite

The composite of the dehydration membrane may comprise a polyether block amide (PEBA), a poly(diallyldimethylammonium chloride)(PDADMA), a poly(acrylamide-co-diallyldimethylammonium chloride)(PACD), a poly(sodium 4-styrenesulfonate)(PSS), or a combination thereof. In some embodiments, the PEBA may be the commercially available polyether block amide (PEBAX). In addition, these selectively permeable membranes may also be prepared using water as a solvent, which can make the manufacturing process much more environmentally friendly and cost effective.

In some embodiments, the composite of the dehydration membrane may be coated on the support. Additionally, an additive, surfactant, a binder, or a combination thereof can also be present in the mixture. The mixture may form covalent bonds, such as crosslinking bonds, or noncovalent bond, such as hydrogen bonding or ionic interaction, between the constituents of the composite (e.g., the polymer(s), surfactant, binder, and/or additives).

The composite can have any suitable thickness. For example, some polymeric layers may have a thickness of about 0.1-10 μm, 0.1-0.5 μm, about 0.5-1 μm, about 1-1.5 μm, about 1.5-2 μm, about 2-2.5 μm, about 2.5-3 μm, about 3-3.5 μm, about 3.5-4 μm, about 4-4.5 μm, about 4.5-5 μm, about 5-5.5 μm, about 5.5-6 μm, about 6-6.5 μm, about 6.5-7 μm, about 7-7.5 μm, about 7.5-8 μm, about 8-8.5 μm, about 8.5-9 μm, about 9-9.5 μm, about 9.5-10 μm, about 1.8-2.2 μm, about 2.8-3.2 μm, about 3.8-4.2 μm, about 4.8-5.2 μm, or any thickness in a range bounded by any of these values. Ranges or values above that encompass the following thicknesses are of particular interest: about 2 μm, about 3 μm, about 4 μm, or about 5 μm.

### Matrix Polymer

As mentioned above, the composite, such as a polymer composite, can comprise a hydrophilicity and/or matrix polymer agent. In some embodiments, the hydrophilicity and/or matrix polymer agent can be a PEBA, a PDADMA, a PACD, a PSS, or a combination thereof. In some embodiments, the composite may be formed by reacting a mixture of a PEBA, a PDADMA, a PACD, a PSS, or a combination thereof.

In some embodiments, the composite, hydrophilic matrix polymer may comprise a PEBA. In some embodiments, the PEBA can be a PEBAX® branded PEBA (Arkema Inc., King of Prussia, Pa., USA).

Any suitable amount of a PEBA may be used. In some embodiments, the PEBA has a weight ratio of poly(ethylene oxide) to polyamide of PEBA is about 0.1-0.5, about 0.5-1, about 1-1.5, about 1.5-2, about 2-3, about 3-4, about 4-5, about 1-2, about 1.2-1.4, about 1.4-1.6, or about 1.5 (60 mg of polyethylene oxide to 40 mg of polyamide is a ratio of 1.5).

In some embodiments, the hydrophilic polymer and/or crosslinker can be a PDADMA.

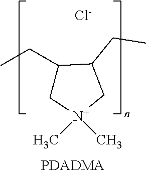

The PDADMA may have any suitable molecular weight, such as less than 100,000 Da, about 200,000-350,000 Da, about 400,000-500,000 Da, about 1-500,000 Da, about 1-200,000 Da, about 200,000-400,000 Da, about 400,000-600,000 Da, about 10,000-500,000 Da, about 10,000-100,000 Da, about 10,000-40,000 Da, about 40,000-70,000 Da, or about 70,000-100,000.

Any suitable amount of a PDADMA may be used. In some embodiments, the hydrophilic polymer and/or crosslinker can comprise a PEBA and a PDADMA. Any suitable ratio of the PDADMA to the PEBA may be used, such as about 0.01-0.6 (1 mg of the PDADMA and 100 mg of the PEBA is a ratio of 1), about 0.1-0.2, about 0.2-0.3, about 0.3-0.4, about 0.4-0.5, about 0.5-0.6, about 0.05, about 0.1, or about 0.33.

In some embodiments, the hydrophilic polymer and/or crosslinker can be a PACD.

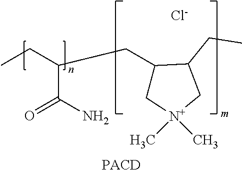

Any suitable amount of a PACD may be used. In some embodiments, the hydrophilic polymer and/or crosslinker can comprise a PEBA and PCAD. Any suitable ratio of a PACD to a PEBA may be used, such as about 0.01-0.6 (1 mg of PCAD and 100 mg of a PEBA is a ratio of 1), about 0.1-0.2, about 0.2-0.3, about 0.3-0.4, about 0.4-0.5, about 0.5-0.6, about 0.2-0.25, about 0.25-0.3, about 0.3-0.35, about 0.35-0.4, about 0.4-0.45, about 0.45-0.5, or about 0.33.

In some embodiments, the hydrophilic polymer and/or crosslinker can comprise a PSS. The PSS may have any suitable molecular weight, such as about 500,000-2,000,000 Da or about 1,000,000 Da.

Any suitable amount of a PSS may be used. In some embodiments, the hydrophilic polymer and/or crosslinker can comprise a PEBA and a PSS. Any suitable ratio of a PSS to a PEBA may be used, such as about 0.01-0.6 (1 mg of a PSS and 100 mg of a PEBA is a ratio of 1), about 0.1-0.2, about 0.2-0.3, about 0.3-0.4, about 0.4-0.5, about 0.5-0.6, about 0.2-0.25, about 0.25-0.3, about 0.3-0.35, about 0.35-0.4, about 0.4-0.45, about 0.45-0.5, or about 0.33.

### Additive

An additive or an additive mixture may, in some instances, improve the performance of the composite. Some polymeric composites can also comprise an additive mixture. In some embodiments, the additive mixture can comprise calcium chloride, lithium chloride, sodium lauryl sulfate, a lignin, or any combination thereof. In some embodiments, any of the moieties in the additive mixture may also be bonded with the material matrix. The bonding can be physical or chemical (e.g., covalent). The bonding can be direct or indirect.

### Protective Coating

Some membranes may further comprise a protective coating. For example, the protective coating can be disposed on top of the membrane to protect it from the environment. The protective coating may have any composition suitable for protecting a membrane from the environment. Many polymers are suitable for use in a protective coating such as one or a mixture of hydrophilic polymers, e.g. polyvinyl alcohol (PVA), polyvinyl pyrrolidone (PVP), polyethylene glycol (PEG), polyethylene oxide (PEO), polyoxyethylene (POE), polyacrylic acid (PAA), polymethacrylic acid (PMMA) and polyacrylamide (PAM), polyethylenimine (PEI), poly(2-oxazoline), polyethersulfone (PES), methyl cellulose (MC), chitosan, poly (allylamine hydrochloride) (PAH) and poly (sodium 4-styrene sulfonate) (PSS), and any combinations thereof. In some embodiments, the protective coating can comprise PVA.

### Methods of Making Dehydration Membranes

Some embodiments include methods for making a dehydration membrane comprising: (a) mixing the polymer, e.g., PEBAX, and an additive in an aqueous mixture to generate a composite coating mixture; (b) applying the coating mixture on a porous support to form a coated support; (c) repeating step (b) as necessary to achieve the desired thickness of coating; and (d) drying the coating at a temperature of about 60-100° C. for about 30 seconds to about 3 hours. In some embodiments, the method optionally comprises pre-treating the porous support. In some embodiments, the method optionally further comprises coating the assembly with a protective layer. An example of a possible method embodiment of making an aforementioned membrane is shown in FIG. 2.

The mixture comprising the matrix polymer may include a solvent or solvent mixture, such as an aqueous solvent, e.g. water optionally in combination with a water-soluble organic solvent such as an alcohol (e.g. methanol, ethanol, isopropanol, etc.), acetone, etc. In some embodiments, the aqueous solvent mixture contains ethanol and water.

In some embodiments, the porous support can be optionally pre-treated to aid in the adhesion of the composite layer to the porous support. In some embodiments, the porous support can be modified to become more hydrophilic. For example, the modification can comprise a corona treatment using 70 W power with 2 counts at a speed of 0.5 m/min. In some embodiments, the porous support can be stretched polypropylene. In some embodiments the polypropylene is distended from a first length to a second length, where in the second length is at least 25%, 40%, 50%, 100%, 200%, 500% and/or greater than 1000% of the first length. In some embodiments the polypropylene is distended from a first length to a second length, within 1 minute, 5 minutes, 10 minutes and/or 1 hour, wherein the second length is at least 25%, 40%, 50%, 100%, 200%, 500% and/or greater than 1000% of the first length). In some embodiments, the distending is performed at a constant rate. A suitable stretched polypropylene can be Celgard 2500 polypropylene (Celgard LLC, Charlotte, N.C., USA). An exemplary stretching methodology can be on a stretching apparatus like KARO IV stretcher (manufactured by Bruckner Maschinenbau GmbH & Co. KG, Siegsdorf, GE); a preheating temperature of about 145 to 160° C.; preheating time of about 60 seconds; stretch ratio: sequential biaxial stretching to 5 times in longitudinal direction (machine direction) times; 7 times in transverse direction (area stretch ratio: 35); stretching rate of about 6 m/min; and the film thickness can be adjusted by way of preheating temperature as described in United States Patent Publication 2017/0190891.

In some embodiments, applying the mixture to the porous support can be done by methods known in the art for creating a layer of desired thickness. In some embodiments, applying the coating mixture to the substrate can be achieved by vacuum immersing the substrate into the coating mixture first, and then drawing the solution onto the substrate by applying a negative pressure gradient across the substrate until the desired coating thickness can be achieved. In some embodiments, applying the coating mixture to the substrate can be achieved by blade coating, spray coating, dip coating, die coating, or spin coating. In some embodiments, the method can further comprise gently rinsing the substrate with deionized water after each application of the coating mixture to remove excess loose material. In some embodiments, the coating is done such that a composite layer of a desired thickness is created. In some embodiments, the number of layers can range from 1-250, from about 1-100, from 1-50, from 1-20, from 1-15, from 1-10, or 1-5. This process results in a fully coated substrate, or a coated support.

The coating mixture that is applied to the substrate may include a solvent or a solvent mixture, such as an aqueous solvent, e.g. water optionally in combination with a water-soluble organic solvent such as an alcohol (e.g. methanol, ethanol, isopropanol, etc.), acetone, etc. In some embodiments, the aqueous solvent mixture contains ethanol and water.

In some embodiments, the porous support is coated at a coating speed that is 0.5-15 meter/min, about 0.5-5 meter/min, about 5-10 meter/min, or about 10-15 meter/min. These coating speeds are particularly suitable for forming a coating layer having a thickness of about 1-10 μm, about 1 μm, about 1-2 μm, or about 2-3 μm, about 3-4 μm, about 4-5 μm, about 5-6 μm, about 6-7 μm, about 7-8 μm, about 8-9 μm, about 9-10 μm, about 2 μm, about 3 μm, about 4 μm, or about 5 μm.

For some methods, curing the coated support can then be done at temperatures and times sufficient to facilitate crosslinking between the moieties of the aqueous mixture deposited on the porous support. In some embodiments, the coated support can be heated at a temperature of about 60-70° C., about 70-80° C., about 80-90° C., about 90-100° C., or about 80° C. In some embodiments, the coated support can be heated for a duration of at least about 30 seconds, at least about 1 minute, at least about 5 minutes, at least about 6 minutes, at least about 15 minutes, at least about 30 minutes, at least 45 minutes, up to about 1 hour, up to about 1.5 hours, up to about 3 hours; with the time required generally decreasing for increasing temperatures. In some embodiments, the substrate can be heated at about 80° C. for about 8 minutes. This process results in a cured membrane.

In some embodiments, the method for fabricating a membrane can further comprise subsequently applying a protective coating on the membrane. In some embodiments, the applying a protective coating comprises adding a hydrophilic polymer layer. In some embodiments, applying a protective coating comprises coating the membrane with a polyvinyl alcohol aqueous solution. Applying a protective layer can be achieved by methods such as blade coating, spray coating, dip coating, spin coating, and etc. In some embodiments, applying a protective layer can be achieved by dip coating of the membrane in a protective coating solution for about 1-10 minutes, about 1-5 minutes, about 5 minutes, or about 2 minutes. In some embodiments, the method further comprises drying the membrane at a temperature of about 75-120° C. for about 5-15 minutes, or at about 90° C. for about 10 minutes. This process results in a membrane with a protective coating.

### Methods for Reducing Water Vapor Content of a Gas Mixture

A selectively permeable membrane, such as a dehydration membrane, described herein may be used in methods for removing water vapor or reducing water vapor content from an unprocessed gas mixture, such as air, containing water vapor, for applications where dry gases or gases with low water vapor content are desired. The method comprises passing a first gas mixture (an unprocessed gas mixture), such as air, containing water vapor through the membrane, whereby the water vapor is allowed to pass through and removed, while other gases in the gas mixture, such as air, are retained to generate a second gas mixture (a dehydrated gas mixture) with reduced water vapor content.

A dehydrating membrane may be incorporated into a device that provides a pressure gradient across the dehydrating membrane so that the gas to be dehydrated (the first gas) has a higher water vapor pressure than that of the water vapor on the opposite side of the dehydrating membrane where the water vapor is received, then removed, resulting in a dehydrated gas (the second gas).

The permeated gas mixture, such as air, or a secondary sweep stream may be used to optimize the dehydration process. If the membrane were totally efficient in water vapor separation, all the water vapor in the feed stream would be removed, and there would be nothing left to sweep it out of the system. As the process proceeds, the partial pressure of the water vapor on the feed or bore side becomes lower, and the pressure on the shell-side becomes higher. This pressure difference tends to prevent additional water vapor from being expelled from the module. Since the object is to make the bore side dry, the pressure difference interferes with the desired operation of the device. A sweep stream may therefore be used to remove the water vapor from the shell side, in part by absorbing some of the water vapor, and in part by physically pushing the water vapor out.

If a sweep stream is used, it may come from an external dry source or a partial recycle of the product stream of the module. In general, the degree of dehumidification will depend on the pressure ratio of product flow to feed flow (for water vapor across the membrane) and on the product recovery. Good membranes have a high product recovery with low level of product humidity, and/or high volumetric product flow rates.

A dehydration membrane may be used to remove water for energy recovery ventilation (ERV). ERV is the energy recovery process of exchanging the energy contained in normally exhausted building or space air and using it to treat (precondition) the incoming outdoor ventilation air in residential and commercial HVAC systems. During the warmer seasons, an ERV system pre-cools and dehumidifies while humidifying and pre-heating in the cooler seasons.

In some embodiments, the dehydration membrane has a water vapor transmission rate that is at least 500 g/m²/day, at least 1,000 g/m²/day, at least 1,100 g/m²/day, at least 1,200 g/m²/day, at least 1,300 g/m²/day, at least 1,400 g/m²/day, or at least 1,500 g/m²/day as determined by ASTM E96 standard method.

In some embodiments, the dehydration membrane has a water vapor transmission rate that is at least 5000 g/m²/day, at least 10,000 g/m²/day, at least 20,000 g/m²/day, at least 25,000 g/m²/day, at least 30,000 g/m²/day, at least 35,000 g/m²/day, or at least 40,000 g/m²/day as determined by ASTM D-6701 standard method.

In some embodiments, the dehydration membrane has a gas permeance that is less than 0.001 L/(m²Spa), less than 10⁻⁴ L/(m²Spa), less than 10⁻⁵ L/(m²Spa), less than 10⁻⁶ L/(m²Spa), less than 10⁻⁷ L/(m²Spa), less than 10⁻⁸ L/(m²Spa), less than 10⁻⁹ L/(m²Spa), or less than 10⁻¹⁰ L/(m²Spa), as determined by the Differential Pressure Method.

The membranes described herein can be easily made at low cost and may outperform existing commercial membranes in either volumetric product flow or product recovery.

### Embodiments

The following embodiments are specifically contemplated.

1. A dehydration membrane comprising:

a porous support; and

a composite coated on the porous support, wherein the composite comprises a polyether block amide (PEBA), a poly(diallyldimethylammonium chloride)(PDADMA), a poly(acrylamide-co-diallyldimethylammonium chloride)(PACD), a poly(sodium 4-styrenesulfonate)(PSS), or a combination thereof.

2. The dehydration membrane of embodiment 1, wherein the composite comprises the PEBA.
3. The dehydration membrane of embodiment 2 or 3, wherein the PEBA has a weight ratio of poly(ethylene oxide) to polyamide that is about 1.5.
4. The dehydration membrane of embodiment 1, 2, or 3, wherein the composite comprises the PDADMA.
5. The dehydration membrane of embodiment 4, wherein composite comprises the PDADMA and the PEBA, and the weight ratio of the PDADMA to the PEBA in the composite is about 0.01 to about 0.6.
6. The dehydration membrane of embodiment 5, wherein the composite comprises the PDADMA, and the molecular weight of the PDADMA is about 10,000 to about 500,000 Da.
7. The dehydration membrane of embodiment 5, wherein the composite comprises the PDADMA, and the molecular weight of the PDADMA is less than 100,000 Da.
8. The dehydration membrane of embodiment 1, 2, 3, 4, 5, 6, or 7, wherein the composite comprises the PACD.
9. The dehydration membrane of embodiment 8, wherein the composite comprises the PACD and the PEBA, and the weight ratio of the PACD to the PEBA in the composite is about 0.2 to about 0.4.
10. The dehydration membrane of embodiment 1, 2, 3, 4, 5, 6, 7, 8, or 9, wherein the composite comprises the PSS.
11. The dehydration membrane of embodiment 10, wherein composite comprises the PSS and the PEBA, and the weight ratio of the PSS to the PEBA in the composite is about 0.2 to about 0.4.
12. The dehydration membrane of embodiment 1, 2, 3, 4, 5, 6, 7, 8, 9, 10, or 11, wherein the composite is a layer that has a thickness of 1 to 10 μm.
13. The dehydration membrane of embodiment 1, 2, 3, 4, 5, 6, 7, 8, 9, 10, 11, or 12, wherein the dehydration membrane has a water vapor transmission rate that is at least 1,000 g/m²/day as determined by ASTM E96 standard method.
14. The dehydration membrane of embodiment 1, 2, 3, 4, 5, 6, 7, 8, 9, 10, 11, 12, or 13, wherein the dehydration membrane has a gas permeance that is less than 0.001 L/m2 s Pa as determined by the Differential Pressure Method.
15. The dehydration membrane of embodiment 1, 2, 3, 4, 5, 6, 7, 8, 9, 10, 11, 12, 13, or 14, wherein the porous support comprises stretched polypropylene or stretched polyethylene.
16. A dehydration membrane comprising:

a porous support; and

a composite coated on the porous support comprising a polyether block amide (PEBA).

17. The dehydration membrane of embodiment 16, wherein the porous support comprises polyethylene.
18. The dehydration membrane of embodiment 16 or 17, wherein the porous support comprises polypropylene.
19. The dehydration membrane of embodiment 18, wherein the porous support comprises stretched polypropylene.
20. The dehydration membrane of embodiment 1, 2, 3, 4, 5, 6, 7, 8, 9, 10, 11, 12, 13, 14, 15, 16, 17, 18, or 19, wherein the dehydration membrane has an antimicrobial activity of 2 or higher according to Japanese Industrial Standard Z 2801:2012.
21. A method for dehydrating a gas comprising:

applying a first gas to the dehydration membrane of embodiment 1, 2, 3, 4, 5, 6, 7, 8, 9, 10, 11, 12, 13, 14, 15, 16, 17, 18, 19, or 20; and

allowing water vapor to pass through the dehydration membrane and to be removed;

and generating a second gas that has lower water vapor content than the first gas.
22. A method of making a dehydration membrane comprising:

curing an aqueous mixture that is coated onto a porous support;

wherein the aqueous mixture that is coated onto the porous support is dried at a temperature of 60° C. to 100° C. for about 30 seconds to about 3 hours;

wherein the porous support is coated with the aqueous mixture by applying the aqueous mixture to the porous support, and repeating as necessary to achieve a layer of coating having a thickness of about 100 nm to about 4000 nm; and

wherein the aqueous mixture is formed by mixing a PEBA, a PDADMA, a PACD, a PSS, or a combination thereof, in an aqueous liquid.

23. The method of embodiment 22, wherein the aqueous mixture comprises a solvent mixture that contains ethanol and water.
24. The method of embodiment 22 or 23, wherein the porous support is coated at a coating speed that is 0.5 to 15 meter/min and the resulting coating forms a layer that has a thickness of about 1 μm to about 3 μm.
25. An energy recovery ventilator system comprising a dehydration membrane of embodiment 1, 2, 3, 4, 5, 6, 7, 8, 9, 10, 11, 12, 13, 14, 15, 16, 17, 18, 19, or 20.

### Examples

It has been discovered that embodiments of the selectively permeable membranes described herein have improved performance as compared to other selectively permeable membranes. These benefits are further demonstrated by the following examples, which are intended to be illustrative of the disclosure only and are not intended to limit the scope or underlying principles in any way.

### Membrane Preparation Procedure

### Example Ex-A1: PEBAX/Polypropylene Membrane

1. Coating Solution Preparation.

2.5 g PEBAX MH1657 (Arkema, Inc., King of Prussia, Pa., USA) was dissolved in solvent of 30 mL deionized (DI) water and 70 mL alcohol (Ethanol, IPA) mixture in in 80° C. water bath with stirring. After the PEBAX had dissolved completely, the mixture was cooled to room temperature. 25 mL DI water was added into this 2% wt PEBAX solution.

2. Coating and Drying.

The clearance coating bar was set at 100 μm. A polypropylene film (Celgard 2500, Celgard LLC, Charlotte, N.C., USA) was set upon a vacuum coating stage with a minimum/no wrinkles. The solution prepared as described above was deposited upon the polypropylene (PP) film. The coated film was dried on the stage for 2 min before being moved into oven. The film was then dried in 90° C. oven with air circulation for 3 minutes with a holder on both ends of the coated PP film to reduce wrinkles. This method provided a 2 μm thick layer of PEBAX on polypropylene.

### Example Ex-A2, Ex-A3, Ex-A4

In accordance with the procedures for Ex-A1, examples Ex-A2, Ex-A3, and Ex-A4 may be prepared by using the following modifications: by controlling the clearance of coating bar gap to 150 μm, a 3 μm thick coating layer (Ex-A2) is provided; by controlling the clearance of coating bar gap to 200 μm, a 4 μm thick coating layer (Ex-A3) is provided; by controlling the clearance of coating bar gap to 250 μm, a 5 μm thick coating layer (Ex-A4) is provided.

Alternatively, the thickness of the coating for Ex-A2, Ex-A3, and Ex-A4 can be achieved by using a smaller clearance gap and repeating the coating as necessary to achieve the desired thickness.

### Example 3.1.1: Measurement of Selectively Permeable Membranes

Membranes of Ex-A1, Ex-A2, Ex-A3, Ex-A4 were tested for water vapor transmission rate (WVTR) as described in ASTM E96 standard method using calcium chloride as desiccant, purchased from Kanto Chemical (JIS K8123), at a temperature of 20° C. and 50% relative humidity (RH), and/or for water vapor permeance as described in ASTM E96 standard method, at a temperature of 20° C. and 50% relative humidity (RH), and/or for N2 permeance. Membranes of Ex-A1, EX-A2, EX-A3, and EX-A4 were also tested for N2 permeance. The results are shown in Table 1.

TABLE 1

| | | | | | | WVTR | | |
|---|---|---|---|---|---|---|---|---|
| | | | | WVTR | | (20° C., | Gas | |
| | | | | (20° C., | Gas | 50% RH) | permeance | |
| | | | Thick- | 50% RH) | permeance | After 24 h, 50° C. | | ΔWVTR |
| | Com- | | ness | Before Soaking | | water soak | | (after |
| Ex-# | position | Ratio | (um) | g/m²/day | L/(m²sPa) | g/m²/day | L/(m²sPa) | soaking) |
| Ex-A1 | PEBAX | 100 | 2 | 4324 | 3.7E−6 | 2906 | 5.8E−7 | |
| Ex-A2 | PEBAX | 100 | 3 | 3181 | 6.9E−7 | 2860 | 5.4E−7 | |
| Ex-A3 | PEBAX | 100 | 4 | 3400 | 1.3E−8 | 3711 | 1.3E−9 | |
| Ex-A4 | PEBAX | 100 | 5 | 3326 | 3.6E−9 | 2860 | 9.5E−9 | |

Note:
PEBAX: polyether block amide

### Example 3.1.2. Measurement of Membrane Antimicrobial Activities

The membrane's anti-microbial activity is measured using a procedure that conforms to Japanese Industrial Standard (JIS) Z 2801:2012 (English Version pub. September 2012) for testing anti-microbial product efficacy, which is incorporated herein in its entirety. The organisms used in the verification of antimicrobial capabilities are Escherichia coli. (ATCC® 8739, ATCC).

For the test, a broth is prepared by suspending 8 g of the nutrient powder (Difco™ Nutrient Broth, Becton, Dickinson and Company, Franklin Lakes, N.J. USA) in 1 L of filtered, sterile water, mixing thoroughly and then heating with frequent agitation. To dissolve the powder the mixture is boiled for 1 minute and then is autoclaved at 121° C. for 15 minutes. The night before testing, the Escherichia coli. is added to 2-3 mL of the prepared broth and grown overnight.

On the day of the test, the resulting culture is diluted in fresh media and then is allowed to grow to a density of 10⁸ CFU/mL (or approximately diluting 1 mL of culture into 9 mL of fresh nutrient broth). The resulting solution is then left to re-grow for 2 hours. The re-growth is then diluted by 50 times in sterile saline (NaCl 8.5 g (Aldrich) in 1 L of distilled water) to achieve an expected density of about 1×10⁶ CFU/mL. 50 μL of the dilute provides the inoculation number.

The samples are then cut into 1 inch by 2 inch squares and are placed in a petri dish with the coated side up. Then 50 μL of the dilute is taken and the test specimens are inoculated. A transparent cover film (0.75 in.×1.5 in., 3M, St. Paul, Minn. USA) is then used to help spread the bacterial inoculums, define the spread size, and reduce evaporation. Then, the petri dish is covered with a transparent lid, and left so the bacteria could grow.

When the desired measurement points of 2 hours and 24 hours are achieved, the test specimens and cover film are transferred with sterile forceps into 50 mL conical tubes with 20 mL of saline and the bacteria for each sample is washed off by mixing them for at least 30 seconds in a vortex mixer (120V, VWR Arlington Heights, Ill. USA). The bacteria cells in each solution are then individually transferred using a pump (MXPPUMP01, EMD Millipore, Billerica, Mass. USA) are combined with a filter (Millflex-100, 100 mL, 0.45 μm, white gridded, MXHAWG124, EMD Millipore) into individual cassettes prefilled with tryptic soy agar (MXSMCTS48, EMD Millipore).

Then the cassettes are inverted and placed in an incubator at 37° C. for 24 hours. After 24 hours, the number of colonies on the cassettes is counted. If there are no colonies a zero was recorded. For untreated pieces, after 24 hours the number of colonies is not less than 1×10³ colonies.

Unless otherwise indicated, all numbers expressing quantities of ingredients, properties such as molecular weight, reaction conditions, and etc. used in herein are to be understood as being modified in all instances by the term “about.” Each numerical parameter should at least be construed in light of the number of reported significant digits and by applying ordinary rounding techniques. Accordingly, unless indicated to the contrary, the numerical parameters may be modified according to the desired properties sought to be achieved, and should, therefore, be considered as part of the disclosure. At the very least, the examples shown herein are for illustration only, not as an attempt to limit the scope of the disclosure.

The terms “a,” “an,” “the” and similar referents used in the context of describing embodiments of the present disclosure (especially in the context of the following embodiments) are to be construed to cover both the singular and the plural, unless otherwise indicated herein or clearly contradicted by context. All methods described herein may be performed in any suitable order unless otherwise indicated herein or otherwise clearly contradicted by context. The use of any and all examples, or exemplary language (e.g., “such as”) provided herein is intended merely to better illustrate embodiments of the present disclosure and does not pose a limitation on the scope of any embodiment. No language in the specification should be construed as indicating any non-embodied element essential to the practice of the embodiments of the present disclosure.

Groupings of alternative elements or embodiments disclosed herein are not to be construed as limitations. Each group member may be referred to and embodied individually or in any combination with other members of the group or other elements found herein. It is anticipated that one or more members of a group may be included in, or deleted from, a group for reasons of convenience.

Certain embodiments are described herein, including the best mode known to the inventors for carrying out the embodiments. Of course, variations on these described embodiments will become apparent to those of ordinary skill in the art upon reading the foregoing description. The inventor expects skilled artisans to employ such variations as appropriate, and the inventors intend for the embodiments of the present disclosure to be practiced otherwise than specifically described herein. Accordingly, the embodiments include all modifications and equivalents of the subject matter recited in the embodiments as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the embodiments. Other modifications that may be employed are within the scope of the embodiments. Thus, by way of example, but not of limitation, alternative embodiments may be utilized in accordance with the teachings herein. Accordingly, the embodiments are not limited to embodiments precisely as shown and described.

What is claimed is:

1. A dehydration membrane comprising:
a porous support; and
a composite coated on the porous support, wherein the composite comprises a polyether block amide (PEBA), a poly(diallyldimethylammonium chloride)(PDADMA), a poly(acrylamide-co-diallyldimethylammonium chloride)(PACD), a poly(sodium 4-styrenesulfonate)(PSS), or a combination thereof.

2. The dehydration membrane of claim 1, wherein the composite comprises the PEBA.

3. The dehydration membrane of claim 2, wherein the PEBA has a weight ratio of poly(ethylene oxide) to polyamide that is about 1.5.

4. The dehydration membrane of claim 1, wherein the composite comprises the PDADMA, and the molecular weight of the PDADMA is less than 100,000 Da.

5. The dehydration membrane of claim 1, wherein the composite comprises the PACD.

6. The dehydration membrane of claim 1, wherein the composite comprises the PSS.

7. The dehydration membrane of claim 1, wherein the composite is a layer that has a thickness of about 1 μm to about 10 μm.

8. The dehydration membrane of claim 7, wherein the composite is a layer that has a thickness of about 2 μm to about 5 μm.

9. The dehydration membrane of claim 1, wherein the dehydration membrane has a water vapor transmission rate that is at least 1,000 g/m²/day as determined by ASTM E96 standard method.

10. The dehydration membrane of claim 1, wherein the dehydration membrane has a gas permeance that is less than 0.001 L/m² s Pa as determined by the Differential Pressure Method.

11. The dehydration membrane of claim 1, wherein the porous support comprises stretched polypropylene or stretched polyethylene.

12. A dehydration membrane comprising:
a porous support; and
a composite coated on the porous support comprising a polyether block amide (PEBA).

13. The dehydration membrane of claim 12, wherein the porous support comprises polyethylene.

14. The dehydration membrane of claim 12 or 13, wherein the porous support comprises polypropylene or stretched polypropylene.

15. A method for dehydrating a gas comprising:
applying a first gas to the dehydration membrane of claim 1;
allowing water vapor to pass through the dehydration membrane and to be removed; and
generating a second gas that has lower water vapor content than the first gas.

16. A method of making a dehydration membrane comprising:
curing an aqueous mixture that is coated onto a porous support;
wherein the aqueous mixture that is coated onto the porous support is dried at a temperature of 60° C. to 100° C. for about 30 seconds to about 3 hours;
wherein the porous support is coated with the aqueous mixture by applying the aqueous mixture to the porous support, and repeating as necessary to achieve a layer of coating having a thickness of about 100 nm to about 10000 nm; and
wherein the aqueous mixture is formed by mixing a PEBA, a PDADMA, a PACD, a PSS, or a combination thereof, in an aqueous liquid.

17. The method of claim 16, wherein the aqueous mixture comprises a solvent mixture that contains ethanol and water.

18. The method of claim 1, wherein the porous support is coated at a coating speed that is 0.5 to 15 meter/min to achieve a layer of coating having a thickness of about 1 μm to about 10 μm.

19. An energy recovery ventilator system comprising the dehydration membrane of claim 1.
